(19) United States
(12) Patent Application Publication
(10) Pub. No.: US 2024/0014456 A1
(43) Pub. Date: Jan. 11, 2024

(54) ELECTROCHEMICAL LITHIUM RECOVERY SYSTEM

(71) Applicant: Korea University Research and Business Foundation, Seoul (KR)

(72) Inventors: Seung-Kwan HONG, Yongin-si (KR); Ji-Hun LIM, Seongnam-si (KR); Hyun-Cheal LEE, Uiwang-si (KR)

(73) Assignee: Korea University Research and Business Foundation, Seoul (KR)

(21) Appl. No.: 18/347,093

(22) Filed: Jul. 5, 2023

(30) Foreign Application Priority Data
Jul. 5, 2022 (KR) 10-2022-0082660

(51) Int. Cl. H01M 10/54; C25C 1/02; C25C 7/02; C25C 7/04; C22B 7/00

(52) U.S. Cl. CPC H01M 10/54; C25C 1/02; C25C 7/02; C25C 7/04; C22B 7/007; H01M 10/052

(57) ABSTRACT

Disclosure relates to an electrochemical lithium recovery system, and the electrochemical lithium recovery system is characterized by having a first flow electrode module that selectively extracts lithium ions from an object solution containing a waste battery active material by electrical attraction, and a second flow electrode module recovering the lithium ions extracted by the first flow electrode module, by the electric repulsive force. Accordingly, the electrochemical lithium recovery system does not require a high temperature treatment process, does not require a large amount of chemicals, and can ensure high recovery efficiency.

### BACKGROUND

### 1. Technical Field

The present disclosure relates to an electrochemical lithium recovery system and, more particularly, to an electrochemical lithium recovery system capable of recovering lithium contained in a waste battery.

### 2. Description of the Related Art

A secondary battery is a battery capable of repeating charging and discharging, and has been widely applied to portable electronic communication devices such as a camcorder, a mobile phone, and a notebook PC according to the development of the information and communication industry and the display industry.

For example, the secondary battery may include a lithium secondary battery, a nickel-cadmium battery, a nickel-hydrogen battery, etc. Among the batteries, the lithium secondary battery has energy density that is high per operating voltage and unit weight, and is advantageous in terms of charging speed and light weight, so that the lithium secondary battery has been actively developed and applied.

The lithium secondary battery may include an electrode assembly including an anode, a cathode, and a separating membrane (separator), and an electrolyte impregnating the electrode assembly. The lithium secondary battery may include an exterior material in the form of a pouch, as an example, to receive the electrode assembly and the electrolyte therein.

A lithium metallic oxide can be used as an active material for anode of the lithium secondary battery. The lithium metallic oxide may additionally contain transition metals such as nickel, cobalt, and manganese.

As the above-mentioned expensive valuable metals are used for the active material for anode, more than 20% of the manufacturing cost is spent on manufacturing an anode material. In addition, as environmental protection issues is becoming recently important, research on a method for recycling the active material for anode is being conducted.

In particular, as the production of electric vehicles has been increased recently, the demand for lithium, i.e., a key material, has exceeded the supply, and the importance of research to recover lithium from waste batteries using lithium is increasing.

Conventionally, a pyrometallurgical process and a hydrometallurgical process are used as a method for recovering lithium from a waste battery. The pyrometallurgical process includes high-temperature treatment and reduction of a waste battery active material in the form of metallic oxide, addition of heat treatment powder, water, and CO2, filtration and evaporation, and recovery of lithium in the form of Li2CO3.

The hydrometallurgical process includes acid treatment of a waste battery active material, metallic material leaching, metallic ion extraction with inorganic/organic acids, addition of Na2CO3, filtration and evaporation, and recovery of lithium in the form of Li2CO3.

The pyrometallurgical process or the hydrometallurgical process described above utilizes high temperature and strong acid to leach recoverable ions from a waste battery, and then crystallizes lithium in solid form by adding chemicals to recover the lithium.

However, the above methods cause high energy consumption due to high temperature, require a post-treatment process due to the use of a large amount of chemicals, and cause environmental pollution problems, which are disadvantages.

### SUMMARY

Accordingly, the present disclosure has been made keeping in mind the above problems, and the present disclosure is intended to provide an electrochemical lithium recovery system that does not require a high temperature treatment process, does not require a large amount of chemicals, and can ensure high recovery efficiency.

The above-described objective is achieved by an electrochemical lithium recovery system according to the present disclosure, the electrochemical lithium recovery system including a first flow electrode module selectively extracting lithium ions from an object solution containing a waste battery active material by electrical attraction; and a second flow electrode module recovering the lithium ions extracted by the first flow electrode module, by an electric repulsive force.

At this point, the first flow electrode module may include: a first anode channel in which a first front end fluid may flow and to which anode may be applied; a first cathode channel in which a second front end fluid may flow and to which cathode may be applied; a first flow channel in which the object solution may flow; and a first front end ion exchange membrane dividing the first cathode channel and the first flow channel from each other, and allowing selectively penetration of 1 valent ions so that the lithium ions in the object solution may be permeatible towards the second front end fluid, wherein, by electrical attraction of the first cathode channel, the lithium ions of +1 valent may penetrate through the first front end cation exchange membrane.

Furthermore, the second flow electrode module may include: a second anode channel into which the second front end fluid discharged from the first cathode channel may be introduced and flow therein, and to which anode may be applied; second cathode channel in which a second rear end fluid may flow and to which cathode may be applied; a second flow channel in which treated water may flow; and a first rear end ion exchange membrane dividing the second anode channel and the second flow channel from each other, wherein, by an electric repulsive force of the second anode channel, the lithium ions may penetrate through the first rear end ion exchange membrane to be recovered to the treated water.

The second front end fluid flowing in the first cathode channel may include a manganese oxide solution; and the lithium ions penetrating through the first front end ion exchange membrane may be absorbed to a manganese oxide in the second front end fluid to be introduced to the second anode channel.

The object solution may be created by leaching the waste battery active material into a sulfuric acid solution; and lithium hydroxide contained in the waste battery active material may react in the sulfuric acid solution to be introduced into the first flow channel in a lithium sulfate state.

The first flow electrode module may include a second front end ion exchange membrane dividing the first anode channel and the first flow channel from each other; and by electrical attraction of the first anode channel, sulfuric acid ions in the object solution may penetrate through the second front end ion exchange membrane to be introduced into the first front end fluid.

The first front end fluid discharged from the first anode channel may be introduced into the second cathode channel, and may serve as the second rear end fluid in the second cathode channel.

The second flow electrode module may further include: a second rear end ion exchange membrane dividing the second anode channel and the second flow channel from each other; and a bi-polar ion exchange membrane dividing the second flow channel into a first recovery channel at the side of the second anode channel, and a second recovery channel at the side of the second cathode channel, wherein, by an electric repulsive force of the second anode channel, the lithium ions penetrating through the first rear end ion exchange membrane may be introduced into the first recovery channel; and by an electric repulsive force of the second cathode channel, the sulfuric acid ions in the second rear end fluid may penetrate through the second rear end ion exchange membrane to be introduced into the second recovery channel.

The sulfuric acid ions recovered through the second recovery channel may be reused to create the object solution.

The first front end fluid may contain activated carbon.

According to the above-described configuration, according to the present disclosure, there is provided the electrochemical lithium recovery system that does not require a high temperature treatment process, does not require a large amount of chemicals, and can ensure high recovery efficiency.

A manganese oxide is used as a flow electrode, there is provided the effect capable of increasing selective absorption efficiency with respect to lithium ions.

The first flow electrode module and the second flow electrode module are configured as a set to extract lithium ions in the front end module and to recover the lithium ions in the following module, so that continuous operation is possible.

As the lithium ions extracted by the first flow electrode module, and sulfuric acid ions are released in the second flow electrode module by the opposite charge towards the treated water to be recovered, there is provided the effect in which the lithium ions can be recovered and the sulfuric acid ions can be reused.

### BRIEF DESCRIPTION OF THE DRAWINGS

FIG. 1 is a view showing configuration of an electrochemical lithium recovery system according to an embodiment of the present disclosure;

FIG. 2 is a view showing configuration of a first flow electrode module of the electrochemical lithium recovery system according to the embodiment of the present disclosure; and

FIG. 3 is a view showing configuration of a second flow electrode module of the electrochemical lithium recovery system according to the embodiment of the present disclosure.

### DETAILED DESCRIPTION

The above and other objectives, features, and advantages of embodiments of the present disclosure, and a method of achieving them will be more clearly understood with reference to the embodiments described below in detail in conjunction with the accompanying drawings. However, the present disclosure is not limited to the following embodiments, and can be embodied in various forms different from each other, and embodiments of the present disclosure are presented to make complete disclosure of the present disclosure and help those who are ordinarily skilled in the art to which the present disclosure belongs understand the spirit and scope of the present disclosure. The present disclosure is only defined by the scope of the claims. The same reference numerals are used throughout the specification to designate the same or similar components.

Hereinbelow, embodiments of the present disclosure will be described in detail with reference to accompanying drawings.

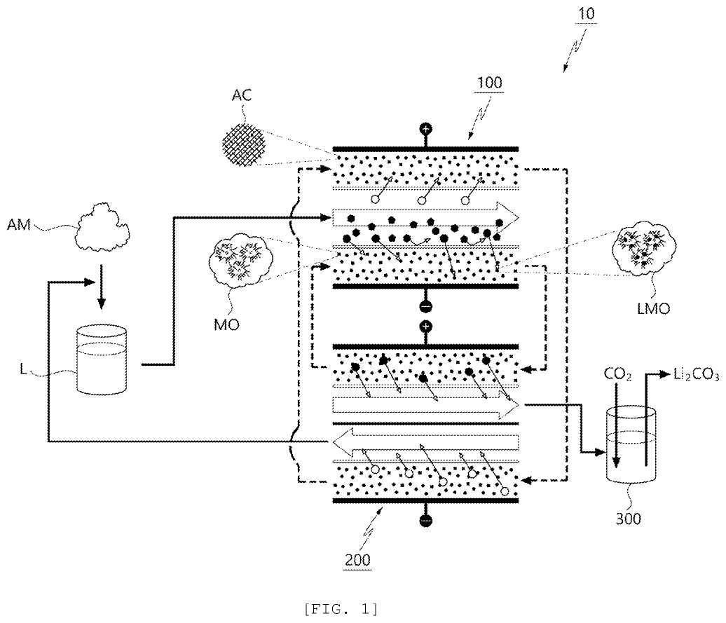

FIG. 1 is a view showing configuration of an electrochemical lithium recovery system 10 according to an embodiment of the present disclosure.

Referring to FIG. 1, according to the embodiment of the present disclosure, the electrochemical lithium recovery system 10 may include a first flow electrode module 100 and a second flow electrode module 200.

In the embodiment of the present disclosure, the first flow electrode module 100 and the second flow electrode module 200 are configured based on a flow-electrode capacitive deionization (FCDI) system.

At this point, the first flow electrode module 100 selectively extracts lithium ions from an object solution containing a waste battery active material AM, by electrical attraction, and the second flow electrode module 200 may recover the lithium ions extracted by the first flow electrode module 100, by an electric repulsive force.

The embodiment of the present disclosure illustrates that the waste battery active material AM, i.e., an active material AM extracted from a waste battery is leached into a storage tank L in which a sulfuric acid solution is stored to create the object solution, and the created object solution is introduced into the first flow electrode module 100.

At this point, lithium is contained in the waste battery active material AM in the form of lithium hydroxide (LiOH), and is converted into sulfuric acid lithium (Li2SO2) in the sulfuric acid solution and is introduced into the first flow electrode module 100.

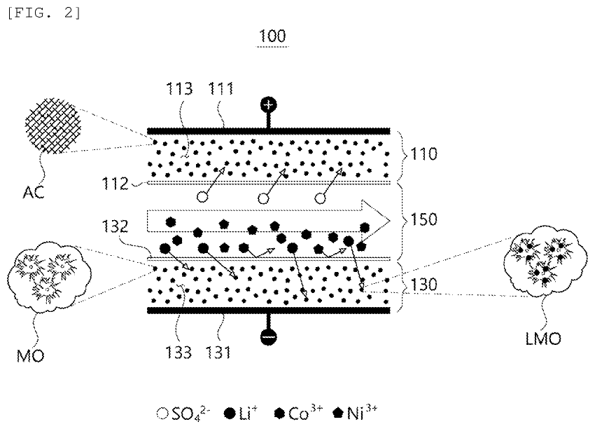

FIG. 2 is a view showing configuration of a first flow electrode module 100 of the electrochemical lithium recovery system 10 according to the embodiment of the present disclosure; and

Referring to FIG. 2, according to the embodiment of the present disclosure, the first flow electrode module 100 may include a first anode channel 113, a first cathode channel 133, a first flow channel 150, and a first front end ion exchange membrane 132. Furthermore, according to the embodiment of the present disclosure, the first flow electrode module 100 may include a second front end ion exchange membrane 112.

According to the embodiment of the present disclosure, the object solution flows into the first flow channel 150. At this point, the first flow channel 150 is formed by the first front end ion exchange membrane 132 and the second front end ion exchange membrane 112.

The first anode channel 113 is formed between the second front end ion exchange membrane 112 and a first anode panel 111. At this point, first front end fluid flows into the first anode channel 113, and positive power is applied through the first anode panel 111. At this point, the first front end fluid may be activated carbon (AC) solution.

The first cathode channel 133 is formed between the first front end ion exchange membrane 132 and a first cathode panel 131. At this point, second front end fluid flows into the first cathode channel 133, and negative power is applied through the first cathode panel 131.

According to the embodiment of the present disclosure, the first front end ion exchange membrane 132 divides the first cathode channel 133 and the first flow channel 150 from each other. Furthermore, the first front end ion exchange membrane 132 allows selectively penetration of 1 valent ions. The embodiment of the present disclosure illustrates that a cation exchange membrane is applied as the first front end ion exchange membrane 132 so that the lithium ions, i.e., +1 valent ions, may penetrate through the first front end ion exchange membrane 132.

According to the above-described structure, when power is applied to through the first anode panel 111 and the first cathode panel 131, the second front end fluid flowing into the first cathode channel 133 have (−) charge, and an ionic substance having (+) charge is moved towards the first cathode channel 133 by the electrical attraction according to the (−) charge.

As shown in FIG. 2, in addition to the lithium ions (Li+), the object solution may include sulfuric acid ions (S042−) by the sulfuric acid solution used for leaching the waste battery active material AM, and a cobalt ion (Co3+), a nickel ion (Ni3+), and the like.

At this point, as (−) charge is applied to the first cathode channel 133, the ionic substance having (+) charge is moved to the first cathode channel 133, and since the first front end ion exchange membrane 132 allows selectively penetration of only +1 valent ions, only the lithium ions, i.e., the +1 valent ions, penetrate the first front end ion exchange membrane 132 to be moved to the first cathode channel 133.

According to the above-described configuration, selective extraction of the lithium ions from the waste battery active material AM including various substances is possible.

At this point, the embodiment of the present disclosure illustrates that the second front end fluid flowing the first cathode channel 133 includes a manganese oxide (MO) solution. The manganese oxide MO has high absorbability with respect to the lithium ions, and the lithium ions penetrating the first front end ion exchange membrane 132 are absorbed to the manganese oxide MO in the second front end fluid to flows LMO. Therefore, selective extraction of lithium ions, and extraction efficiency thereof can be improved.

Meanwhile, according to the embodiment of the present disclosure, the second front end ion exchange membrane 112 may consist of an anion exchange membrane allowing selective penetration of anion.

Furthermore, by electrical attraction of the first anode channel 113 according to (+) charge applied to the first anode channel 113, the sulfuric acid ions in the object solution may penetrate the second front end ion exchange membrane 112 to be introduced into the first front end fluid. At this point, description of the sulfuric acid ions introduced into the first front end fluid will be described below.

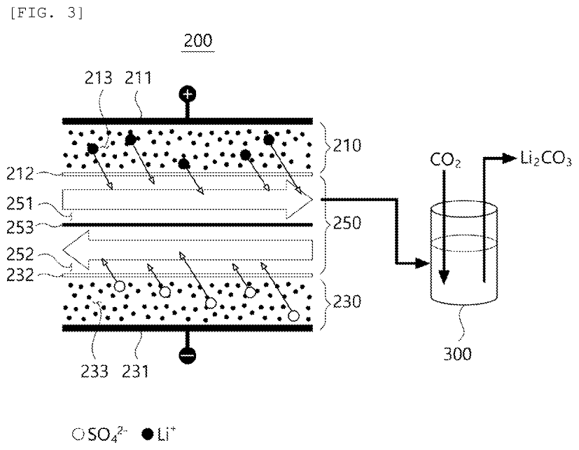

Hereinbelow, referring to FIG. 3, the second flow electrode module 200 according to the embodiment of the present disclosure will be described in detail.

According to the embodiment of the present disclosure, the second flow electrode module 200 may include a second anode channel 213, a second cathode channel 233, a second flow channel 250, and a first rear end ion exchange membrane 212. Furthermore, the second flow electrode module 200 may include a second rear end ion exchange membrane 232 and a bi-polar ion exchange membrane 253.

According to the embodiment of the present disclosure, the treated water flows into the second flow channel 250. Furthermore, the first flow channel 150 is formed by the first rear end ion exchange membrane 212 and the second rear end ion exchange membrane 232.

The second anode channel 213 is formed between the first rear end ion exchange membrane and the second anode panel 211. At this point, the second front end fluid discharged from the first cathode channel 133 is introduced into the second anode channel 213 and flows therein. As described above, the lithium ions are extracted and flow together with the second front end fluid, and may be moved while being absorbed to the manganese oxide MO. At this point, positive power is applied to the second anode channel through the second anode panel 211.

The second cathode channel 233 is formed between the second rear end ion exchange membrane 232 and a second cathode panel 231. At this point, the second rear end fluid flows into the second cathode channel 233, and negative power is applied through the second cathode panel 231.

The embodiment of the present disclosure illustrates that the first front end fluid discharged from the first anode channel 113 is introduced into the second cathode channel 233. In other words, the first front end fluid discharged from the first anode channel 113 serves as the second rear end fluid flowing through the second cathode channel 233.

According to the embodiment of the present disclosure, the first rear end ion exchange membrane 212 divides the second anode channel 213 and the second flow channel 250 from each other. Furthermore, the first rear end ion exchange membrane 212 may allow selectively penetration of the 1 valent ions. The embodiment of the present disclosure illustrates that the cation exchange membrane is applied as the first rear end ion exchange membrane 212 so that the lithium ions, i.e., the +1 valent ions, may penetrate through the first rear end ion exchange membrane 212.

According to the above-described structure, when power is applied through the second anode panel 211 and the second cathode panel 231, the second front end fluid flowing into the second anode channel 213 have (+) charge, and an ionic substance having (+) charge is moved towards the second cathode channel 233 by the electrical repulsive force according to the (+) charge. In other words, the lithium ions of (+) charge extracted from the first flow electrode module 100 penetrate through the first rear end ion exchange membrane 212 to be moved to the second flow channel 250 in which the treated water flows.

Therefore, as the treated water of the second flow channel 250 is recovered, recovery of the lithium ions is possible.

Meanwhile, the second rear end ion exchange membrane 232 divides the second anode channel 213 and the second flow channel 250 from each other. At this point, the second rear end ion exchange membrane 232 may be composed of the anion exchange membrane through which anions selectively penetrate.

It is illustrated that the bi-polar ion exchange membrane 253 according to the embodiment of the present disclosure divides the second flow channel 250 into a first recovery channel 251 at the side of the second anode channel 213 and a second recovery channel 252 at the side of the second cathode channel 233.

Accordingly, an electric repulsive force of the second anode channel 213 allows the lithium ions penetrating through the first rear end ion exchange membrane 212 to be introduced into the first recovery channel 251. Furthermore, an electric repulsive force of the second cathode channel 233 allows the second rear end fluid, i.e., the sulfuric acid ions in the first front end fluid discharged from the first anode channel 113, to penetrate through the second rear end ion exchange membrane 232 to be introduced into the second recovery channel 252.

Therefore, as the treated water flowing in the first recovery channel 251 is recovered, recovery of the lithium ions is possible, and as the treated water flowing in the second recovery channel 252 is recovered, recovery of the sulfuric acid ions is possible.

At this point, the treated water containing the sulfuric acid ions recovered through the second recovery channel 252 is reused to generate the object solution, thereby reducing the amount of use of sulfuric acid used for generating the object solution.

Through the above-described process, the treated water containing the lithium ions may be received in a recovery tank 300. Then, when carbonate is injected into the recovered treated water, lithium recovery in the form of lithium carbonate is possible.

Although the embodiments of the present disclosure have been disclosed for illustrative purposes, those who are ordinarily skilled in the art to which the present disclosure belongs will appreciate that the embodiments can be modified without departing from the scope and sprit of the present disclosure. The scope of the present disclosure should be defined by the accompanying claims and equivalents thereof.

### DESCRIPTIONS FOR THE REFERENCE NUMBER OF THE FIGURES

10: electrochemical lithium recovery system
100: first flow electrode module
111: first anode panel
112: second front end ion exchange membrane
113: first anode channel
131: first cathode panel
132: first front end ion exchange membrane
133: first cathode channel
150: first flow channel
200: second flow electrode module
211: second anode panel
212: first front end ion exchange membrane
213: second anode channel
231: second cathode panel
232: second rear end ion exchange membrane
233: second cathode channel
250: second flow channel
251: first recovery channel
252: second recovery channel
253: bi-polar ion exchange membrane
300: recovery tank

1. An electrochemical lithium recovery system comprising:
a first flow electrode module selectively extracting lithium ions from an object solution containing a waste battery active material by electrical attraction; and
a second flow electrode module recovering the lithium ions extracted by the first flow electrode module, by an electric repulsive force.

2. The electrochemical lithium recovery system of claim 1, wherein the first flow electrode module comprises:
a first anode channel in which a first front end fluid flows and to which anode is applied;
a first cathode channel in which a second front end fluid flows and to which cathode is applied;
a first flow channel in which the object solution flows; and
a first front end ion exchange membrane dividing the first cathode channel and the first flow channel from each other, and allowing selectively penetration of 1 valent ions so that the lithium ions in the object solution are permeatible towards the second front end fluid,
wherein, by electrical attraction of the first cathode channel, the lithium ions of +1 valent penetrate through the first front end cation exchange membrane.

3. The electrochemical lithium recovery system of claim 2, wherein the second flow electrode module further comprises:
a second anode channel into which the second front end fluid discharged from the first cathode channel is introduced and flows therein, and to which anode is applied;
a second cathode channel in which a second rear end fluid flows and to which cathode is applied;
a second flow channel in which treated water flows; and
a first rear end ion exchange membrane dividing the second anode channel and the second flow channel from each other,
wherein, by an electric repulsive force of the second anode channel, the lithium ions penetrate through the first rear end ion exchange membrane to be recovered to the treated water.

4. The electrochemical lithium recovery system of claim 3, wherein the second front end fluid flowing in the first cathode channel includes a manganese oxide solution; and
the lithium ions penetrating through the first front end ion exchange membrane are absorbed to a manganese oxide in the second front end fluid to be introduced to the second anode channel.

5. The electrochemical lithium recovery system of claim 3, wherein the object solution is created by leaching the waste battery active material into a sulfuric acid solution; and
lithium hydroxide contained in the waste battery active material reacts in the sulfuric acid solution to be introduced into the first flow channel in a lithium sulfate state.

6. The electrochemical lithium recovery system of claim wherein the first flow electrode module comprises a second front end ion exchange membrane dividing the first anode channel and the first flow channel from each other; and
by electrical attraction of the first anode channel, sulfuric acid ions in the object solution penetrate through the second front end ion exchange membrane to be introduced into the first front end fluid.

7. The electrochemical lithium recovery system of claim 6, wherein the first front end fluid discharged from the first anode channel is introduced into the second cathode channel, and serves as the second rear end fluid in the second cathode channel.

8. The electrochemical lithium recovery system of claim 7, wherein the second flow electrode module further comprises:
a second rear end ion exchange membrane dividing the second anode channel and the second flow channel from each other; and
a bi-polar ion exchange membrane dividing the second flow channel into a first recovery channel at the side of the second anode channel, and a second recovery channel at the side of the second cathode channel,
wherein, by an electric repulsive force of the second anode channel, the lithium ions penetrating through the first rear end ion exchange membrane are introduced into the first recovery channel; and
by an electric repulsive force of the second cathode channel, the sulfuric acid ions in the second rear end fluid penetrate through the second rear end ion exchange membrane to be introduced into the second recovery channel.

9. The electrochemical lithium recovery system of claim 8, wherein the sulfuric acid ions recovered through the second recovery channel are reused to create the object solution.

10. The electrochemical lithium recovery system of claim 3, wherein the first front end fluid contains activated carbon.
